(19) United States
(12) Patent Application Publication
(10) Pub. No.: US 2018/0258001 A1
(43) Pub. Date: Sep. 13, 2018

(54) Fertilizer for Salt-Sensitive Crops

(71) Applicants: Gregory A. BAME, Marion, OH (US); Tommy ROACH, Marion, OH (US); Nachurs Alpine Solutions, Corp., Marion, OH (US)

(72) Inventors: Gregory Bame, Marion, OH (US); Tommy Roach, Lubbock, TX (US)

(73) Assignee: Nachurs Alpine Solutions, Corp., Marion, OH (US)

(21) Appl. No.: 15/753,123

(22) PCT Filed: Sep. 8, 2016
(86) PCT No.: PCT/US2016/050802

§ 371 Date: Feb. 15, 2018

Related U.S. Application Data
(60) Provisional application No. 62/215,541, filed on Sep. 8, 2015.

(51) Int. Cl. C05B 17/02; C05C 9/00; C05D 1/00

(52) U.S. Cl. CPC C05B 17/02; C05F 11/08; C05D 1/005; C05C 9/00

(57) ABSTRACT

A fertilizer composition having a salt index not greater than about 42 as measured by electrical conductivity methods is disclosed.

### CROSS-REFERENCE TO PRIOR APPLICATIONS

The present application claims priority to U.S. Patent Application 62/215,541 filed 2015 Sep. 8, currently pending, and PCT Application PCT/US16/50121 filed 2016 Sep. 2, currently pending, both of which are incorporated by reference in their entireties.

### FIELD OF THE INVENTION

The invention relates to a low salt plant fertilizer product comprising soluble nitrogen, a phosphate source, a potassium source, and optionally secondary nutrients selected from the group consisting of sulfur, zinc, boron, calcium, manganese, iron, copper, cobalt, magnesium, or a combination thereof. The fertilizer has a salt index no greater than about 40 as measured by electrical conductivity methods.

### BACKGROUND OF THE INVENTION

In order to maintain healthy growth, plants must extract a variety of nutrients from the soil in which they grow. However, many soils are deficient in the necessary nutrients or the soils contain them only in forms which cannot be readily taken up by plants. To counteract these deficiencies, commercial fertilizing products containing select nutrients are commonly applied to soils in order to improve growth rates and yields obtained from crop plants. For example, phosphates may be added to soil to counteract a lack of available phosphorus.

Fertilizers may be characterized by how they are utilized in agriculture. A “starter fertilizer” is typically used to promote the growth of newly planted crops, particularly newly germinated seeds. Starter fertilizers may be applied in bands or in-furrow. Banding fertilizer mixes the fertilizer with small portions of soil rather than placing the fertilizer in direct contact with the seed. However, banding can be expensive, can result in inconsistent soil fertility, and may create soil disturbance that can adversely affect seed placement. Alternatively, in-furrow treatment places the fertilizer directly with the seed during planting. This eliminates the negative effects seen with banding, but can be stressful to the seed because the seeds can be sensitive to fertilizer salts.

The presence of fertilizer salts near a germinating seed or seedling root can cause injury to the plant. The salt creates a relatively high osmotic pressure in the soil surrounding the seed. This makes it more difficult for the seed to extract water from the soil, and may cause water to be drawn out of the seed thereby desiccating the seed and eventually leading to plant death. Crop tolerances vary widely to increased osmotic potential from fertilizer near the seed. Wheat is moderately tolerant of high-salt conditions while soybeans are very sensitive. Most woody fruit and nut crops tend to be salt-sensitive, and it is generally advised that seed-placed fertilizers not be used because of potential decreased germination. However, this limits the ability of the seed to obtain necessary nutrients.

The measure of the salt concentration that a fertilizer induces in the soil near the growing plant is known as the salt index. The salt index may be expressed in terms of the increase in osmotic pressure of the salt solution produced by a specific material relative to the osmotic pressure of the same weight of sodium nitrate (NaNO₃). However, determining the salt index according to this approach is time consuming and expensive. More commonly, the salt index is expressed in terms of the electrical conductivity of the salt solution of a specific material compared to the electrical conductivity of a salt solution of the same weight of sodium nitrate (NaNO₃). As used herein, “salt index” will refer to the electrical conductivity method of measurement.

Thus, it would be beneficial to have a low-salt fertilizer product that can be used near germinating seeds or seedling roots.

### SUMMARY OF THE PRESENT INVENTION

A new low salt concentration fertilizer comprising soluble nitrogen, a phosphate source and a potassium source, wherein the fertilizer has a neutral to slightly alkaline pH and a salt index not greater than about 40 as measured by electrical conductivity methods is described. Because of the relatively low salt index, the fertilizer composition of the present invention may demonstrate lower phytotoxicity damage compared to other fertilizer products. Optionally, the fertilizer composition may include additives known in the art, such as sulfur, zinc, boron, calcium, manganese, iron, copper, cobalt, magnesium, or a combination thereof. The fertilizer composition of the present invention is intended to be used in all cropping rotations and management practices where it can be placed in-furrow at planting, injected into the soil, surface dribbled in a band, sprayed between crop rows, or broadcast, foliar or fertigation applied to meet the crops' potassium requirements.

### DETAILED DESCRIPTION OF THE PRESENT DEVELOPMENT

The present development is a composition for a low salt concentration fertilizer product. The fertilizer of the present invention comprises water, soluble nitrogen, an organic potassium salt, and a phosphate source. Optionally, the fertilizer may further comprise an acetic acid and/or an inoculant and/or secondary nutrient additives selected from the group consisting of sulfur, zinc, boron, calcium, manganese, iron, copper, cobalt, magnesium, or a combination thereof. The resulting fertilizer has a salt index not greater than about 40 as measured by electrical conductivity methods. The fertilizer composition may be in granule, pellet, dust, powder, true solution, slurry, film, and/or liquid suspension form.

The nitrogen source may be any soluble nitrogen source known in the art for fertilizer use, such as urea, nitrate, urea triazone solution, ammonia, ammonium salts, ammonium hydroxide, amino acids, fish meal or extract, compost extract, kelp extract, shrimp extract, shellfish extract, and combinations thereof. The concentration of the soluble nitrogen source will vary depending on the source selected, but the resulting available nitrogen in the final composition should be up to about 6 wt %. In a preferred embodiment, the soluble nitrogen source is urea and the urea comprises up to about 12.0 wt % of the composition.

The phosphorus is delivered in the form of phosphate and the available phosphate is expressed as P₂O₅ in the final composition. For the present fertilizer composition, the phosphorous or phosphate source is selected from the group consisting of rock phosphate, sodium phosphate, potassium phosphate, phosphoric acid, bone meal, monopotassium phosphate, dipotassium phosphate, tetrapotassium pyrophosphate, ammonium phosphate, calcium phosphate, potassium phosphate generated by reaction of potassium hydroxide with phosphoric acid, and combinations thereof. Preferably, the phosphate source further includes at least one source of orthophosphate. In a preferred embodiment, the phosphate source is phosphoric acid. In a more preferred embodiment, the phosphate source is a phosphoric acid solution having a pH<6.0. The phosphate source may vary thereby affecting the amount needed in the composition, but the resulting available phosphate as expressed as P₂O₅ in the final composition should be from about 0 wt % to about 25 wt %. If an orthophosphate is used, the orthophosphate content should be no less than 50% of the total P₂O₅. Because of their reactivity, it is recommended that polyphosphates, and particularly those made from super phosphoric acid, not be used or be minimized in any composition of the present development.

The resulting available potassium in the final composition should be from about 10 wt % to about 40 wt % as expressed as K₂O, and more preferably from about 14 wt % to about 27 wt %, and most preferably from about 18 wt % to about 27 wt %. Further, the potassium source selected and the amount added to the composition should provide a buffering function to the composition and maintain the pH between 5.5 and 9.0, and more preferably between 7.0 to 8.5.

The available potassium is derived potassium phosphate, organic sources of potassium, animal manure, carboxylic acid salts of potassium, potassium silicate, potassium hydroxide and combinations thereof. The carboxylic acid salts of potassium anticipated by this invention include (1) HCOOK, or (2) CH₃(CH₂)ₓCOOK wherein x=0-4, or (3) MOOC(CR¹R²)ₓCOOK wherein R¹=—H or —OH or —COOM and R²=—H or —OH or —COOM and x=0-4 and M=H or K, or (4) HO(CR¹R²)ₓCOOK wherein R¹=H or a C1 to C4 alkyl group and R²=H or a C1 to C4 alkyl group and x=1-5, or (5) CH₃CO(CR¹R²)ₓCOOK wherein R¹=H or a C1 to C4 alkyl group and R²=H or a C1 to C4 alkyl group and x=1-3. Exemplary carboxylic acid salts of potassium as defined herein include potassium formate, potassium acetate, potassium propionate, potassium butyrate, potassium valerate, potassium hexanoate, potassium oxalate, potassium malonate, potassium succinate, potassium glutarate, potassium adipate, potassium lactate, potassium malate, potassium citrate, potassium glycolate, potassium tartrate, potassium glyoxylate, and potassium pyruvate. In a preferred embodiment, potassium hydroxide and potassium acetate are used in combination.

A relevant consideration when selecting the potassium source(s) is the potential impact on the salt level of the finished fertilizer composition. Because of its commercial availability and relatively low cost, potassium hydroxide is a common potassium source. However, potassium hydroxide has a greater impact on the salt index of a composition than organic salts of potassium (KO₂R). Expressing the relative relationship of potassium derived from potassium hydroxide and potassium derived from organic salts of potassium (KO₂R) as the ratio [K₂O derived from KOH]/[K₂O derived from KO₂R], the lower the ratio the lower the salt contributed by the potassium source. In a preferred embodiment, the ratio is less than about 3.5.

Optionally, the fertilizer may further comprise acetic acid or an inoculant or a combination thereof. The acetic acid is preferably a glacial acetic acid. The inoculant may comprise any of a number of viable organisms or beneficial microbes known in the art.

Further, the fertilizer may optionally comprise a secondary nutrient at a concentration of from 0.0 wt % to about 25.0 wt %, and more preferably from about 0.2 wt % to about 10.0 wt %, wherein the secondary nutrient is derived from a sulfur source, a zinc source, a boron source, a calcium source, a manganese source, an iron source, a copper source, a cobalt source, a magnesium source, or a combination thereof. Sources of secondary nutrients are well known in the art. Some representative examples, without limitation, include potassium thiosulfate, ammonium thiosulfate, zinc ethylenediaminetetraacetic acid (ZnEDTA), calcium ethylene-diaminetetraacetic acid (CaEDTA), ammonium calcium nitrate, manganese ethylenediaminetetraacetic acid (MnEDTA), iron ethylenediaminetetraacetic acid (FeEDTA), iron N-(hydroxyethyl) ethylene-diaminetriacetic acid (FeHEDTA), iron ethylenediamine-N, N¹-bis (2-hydroxyphenylacetic acid) (FeEDDHA), iron ethylene-diamine-di (2-hydroxy-5-sulfophenylacetic acid) (FeEDDHSA), cobalt ethylenediaminetetraacetic acid (CoEDTA), cobalt sulfate, magnesium ethylenediaminetetraacetic acid (MgEDTA), copper ethylene-diaminetetraacetic acid (CuEDTA), sodium borate, disodium octaborate tetrahydrate, boric acid, and combinations thereof. Other additives, such as a poly-aspartic acid or amino polycarboxylic acid or a combination thereof, may also be included in the composition. The resulting available secondary nutrient in the final composition may be from 0 wt % to about 25 wt %.

Water is added to balance the composition.

The following exemplary embodiments, not intended to be limiting with respect to scope of the development, are prepared by slowly adding to water the other composition ingredients, and then mixing at ambient temperature for at least 60 minutes ensuring that the temperature is held below 50° C. The solution is then filtered through a 10 micron filter before packaging. If inoculants are included in the composition, order of addition, residence times, and mixing temperatures may need to be adjusted to ensure viability of the inoculant. Samples A-L represent exemplary embodiments of the present invention, and Samples M-P represent embodiments of prior art formulations.

TABLE I

| | | | | | | | | Secondary | |
|---|---|---|---|---|---|---|---|---|---|
| | Nitrogen | Available | Phosphate | Available | Potassium | Available | Secondary | Nutrient | Salt |
| Sample | Source | N (wt %) | Source | P (wt %) | Source | K (wt %) | Nutrient | (wt %) | Index |
| A | urea + NH₄OH | 10.0 | phosphoric acid | 18.0 | K-acetate + | 4.0 | — | 0 | 19 |
| | | | | | KOH | | | | |
| B | urea | 2.0 | phosphoric acid | 6.0 | K-acetate + | 16.0 | — | 0 | 30 |
| | | | | | KOH | | | | |
| C | urea + NH₄OH + | 3.0 | phosphoric acid | 10.0 | K-acetate + | 13.0 | (NH₄)₂S₂O₃ | 1.0 | 31 |
| | (NH₄)₂S₂O₃ | | | | KOH | | ZnEDTA | 0.1 | |
| D | NH₄OH | 3.2 | orthophosphate | 10.0 | K-acetate + | 13.4 | K₂S₂O₃ | 0.2 | 31 |
| | | | | | K₂S₂O₃ | | FeHEDTA | 2.6 | |
| E | urea | 8.0 | ortho-phosphate | 15.0 | K-formate | 3.0 | CaEDTA | 1.4 | 36 |
| | | | | | | | CuEDTA | 6.8 | |
| F | urea + NH₄OH + | 9.0 | phosphoric acid | 15.0 | K-acetate + | 3.0 | (NH₄)₂S₂O₃ | 1.0 | 36 |
| | (NH₄)₂S₂O₃ | | | | KOH | | ZnEDTA | 0.25 | |
| G | — | 0 | — | 0 | K-acetate + | 19.0 | K₂S₂O₃ | 6.0 | 38 |
| | | | | | K₂S₂O₃ | | | | |
| H | urea + NH₄OH + | 4.0 | phosphoric acid | 13.0 | K-acetate + | 17.0 | (NH₄)₂S₂O₃ | 1.0 | 38 |
| | (NH₄)₂S₂O₃ | | | | KOH | | | | |
| I | urea | 5.9 | ortho-phosphate | 24.0 | K-lactate | 6.3 | MnEDTA | 5.4 | 38 |
| J | urea + NH₄OH | 7.0 | ortho-phosphate | 19.8 | K-acetate + | 4.2 | K₂S₂O₃ | 2.7 | 39 |
| | | | | | K₂S₂O₃ | | ZnEDTA | 0.8 | |
| K | urea + | 8.0 | phosphoric acid | 4.0 | K-acetate + | 6.0 | BNa₃O₃ | 0.1 | 40 |
| | ammonium | | | | KOH | | CuEDTA | 0.2 | |
| | polyphosphate | | | | | | MnEDTA | 1.0 | |
| | | | | | | | ZnEDTA | 1.0 | |
| L | ammonium | 2.0 | phosphoric acid | 8.0 | K-acetate + | 11.0 | K₂S₂O₃ | 1.0 | 42 |
| | polyphosphate | | | | K₂S₂O₃ + KCl | | | | |
| M | urea + NH₄OH | 6.0 | phosphoric acid | 20.0 | KOH | 5.0 | — | — | 45 |
| N | — | 0 | — | 0 | KOH + K₂S₂O₃ | 29 | — | 0 | 53 |
| O | urea + NH₄OH | 9.0 | superphosphoric | 24.0 | K- | 3.0 | FeSO₄ | 0.1 | 55 |
| | | | acid | | polyphosphate | | | | |
| P | urea | 10.0 | phosphoric acid + | 34.0 | — | — | — | — | 63 |
| | | | orthophosphate | | | | | | |

Urea-triazone refers to a urea triazone solution
K-{organic anion} refers to the potassium salt of the organic anion, e.g. K-succinate is potassium succinate
BNa₃O₃ is generically used in Table I to refer to all forms of Sodium Borate

The low salt fertilizer described herein is preferably used for fertilizing agricultural crops. The fertilizer may be applied by a variety of methods, along with other fertilizers or pesticides or by itself, such as: as a starter or other fertilizer, as an in-furrow treatment, as a foliar fertilizer, as a side-dressed treatment after planting, as a soil injected fertilizer, and for broadcast, soil-injection and fertigation applications. The fertilizer may be used in no-tillage and minimal tillage conditions where it can be injected into the soil, surface dribbled in a band, sprayed between crop rows, or broadcast applied to meet the crops' nutrient requirements. The fertilizer can be applied with herbicides and/or pesticides to reduce the number of trips over the field thus saving time, fuel and reducing soil compaction. Some recommended means of application, not intended to limit the scope of the claims, include in-furrow application, foliar application, side-dress treatment after planting, pre-planting soil injection, broadcast application, banding 2×2, fertigation, subsurface drip, drip tape, micro-jet, center pivot, surface drip, flood, sprinkler, and combinations thereof.

The low salt fertilizer is beneficial for fertilizing all crops, but is particularly useful in sandy soil conditions on crops that are salt sensitive. Non-limiting examples of crops which may be treated with the fertilizer of the invention include corn, soybeans, wheat, alfalfa, sugar beets, potatoes, grapes, onions, peppers, lettuce, beans, celery, cauliflower, broccoli, pumpkins, nectarines, tomatoes, other fruits and vegetables, and pulse crops. As is known in the art, the fertilizer is applied at different rates or amounts depending upon the particular crop, the method of fertilization and the soil characteristics.

Unless defined otherwise, all technical and scientific terms used herein have the same meaning as commonly understood by one of ordinary skill in the art to which the presently disclosed subject matter pertains. Representative methods, devices, and materials are described herein, but are not intended to be limiting unless so noted.

The terms “a”, “an”, and “the” refer to “one or more” when used in the subject specification, including the claims. The term “ambient temperature” as used herein refers to an environmental temperature of from about 0° F. to about 120° F., inclusive.

As used herein, the specified terms are defined as follows: (1) “NPK” is an abbreviation for a composite fertilizer containing one or more sources of nitrogen (N), phosphorus (P in the form of P₂O₅) and/or potassium (K in the form of K₂O) at the wt % designated by the specific placeholder N—P—K; (2) “starter fertilizer” is a fertilizer applied in low doses close to the plant seed used to promote the growth of newly planted crops, particularly newly germinated seeds; (3) “banded fertilizer” is a fertilizer applied in low doses along the side of the seed row and either on the surface or below the seed row; (4) “in-furrow application” refers to the process of placing fertilizers directly with the seed during planting; (5) “top-dress” refers to broadcast applications on crops like small grains; (6) “side dress” refers to fertilizer placed at relatively high amounts anywhere from three to four inches from the row to half way between the crop rows; (7) “foliar application” refers to the process of applying liquid fertilizer directly to the leaves of a plant; (8) “broadcast application” refers to a uniform distribution of material on the soil surface; (9) “fertigation” refers to the injection of fertilizer into an irrigation system; and, (10) “true solution” refers to a homogeneous solution.

As used herein, the term “salt index” is determined by measuring the electrical conductivity of a 1% by weight aqueous solution of sodium nitrate and measuring the electrical conductivity of a 1% by weight aqueous solution of the fertilizer composition. The sodium nitrate solution is assigned a salt index value of 100. The salt index of the fertilizer (X) is then determined from the equation:

$$\frac{EC of {NaNO}_{3}}{100} = \frac{EC of Fertilizer}{X}$$

Unless otherwise indicated, all numbers expressing quantities of components, conditions, and otherwise used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, or percentage can encompass variations of, in some embodiments ±20%, in some embodiments ±10%, in some embodiments ±5%, in some embodiments ±1%, in some embodiments ±0.5%, and in some embodiments to ±0.1%, from the specified amount, as such variations are appropriate in the disclosed application.

All compositional percentages used herein are presented on a “by weight” basis, unless designated otherwise.

It is understood that, in light of a reading of the foregoing description, those with ordinary skill in the art will be able to make changes and modifications to the present invention without departing from the spirit or scope of the invention, as defined herein. For example, those skilled in the art may substitute materials supplied by different manufacturers than specified herein without altering the scope of the present invention.

What is claimed is:

1. A composition for a fertilizer product comprising water, soluble nitrogen, a potassium salt, and a phosphate source, and wherein said composition has a salt index not greater than about 42 as measured by electrical conductivity methods.

2. The fertilizer composition of claim 1 wherein the nitrogen source is selected from the group consisting of urea, nitrate, triazone urea, ammonia, ammonium salts, ammonium hydroxide, amino acids, fish meal or extract, compost extract, kelp extract, shrimp extract, shellfish extract, and combinations thereof.

3. The fertilizer of claim 2 wherein the nitrogen source provides from 0.0% to 12.0% available nitrogen in the final composition.

4. The fertilizer composition of claim 1 wherein the phosphate source is selected from the group consisting of rock phosphate, sodium phosphate, potassium phosphate, phosphoric acid, bone meal, monopotassium phosphate, dipotassium phosphate, tetrapotassium pyrophosphate, ammonium phosphate, calcium phosphate, and combinations thereof.

5. The fertilizer of claim 4 wherein the phosphate source provides from 0% to 25% available phosphate in the form of P₂O₅ in the final composition.

6. The fertilizer composition of claim 1 wherein the potassium source is selected from the group consisting of potassium phosphate, organic sources of potassium, animal manure, carboxylic acid salts of potassium, potassium silicate and combinations thereof.

7. The fertilizer of claim 6 wherein the potassium source provides from 10% to about 40% available potassium in the form of K₂O.

8. The fertilizer composition of claim 6 wherein the carboxylic acid salt of potassium is selected from (1) HCOOK, or (2) CH₃(CH₂)ₓCOOK wherein x=0-4, or (3) MOOC(CR¹R²)ₓCOOK wherein R¹=—H or —OH or —COOM and R²=—H or —OH or —COOM and x=0-4 and M=H or K, or (4) HO(CR¹R²)ₓCOOK wherein R¹=H or a C1 to C4 alkyl group and R²=H or a C1 to C4 alkyl group and x=1-5, or (5) CH₃CO(CR¹R²)ₓCOOK wherein R¹=H or a C1 to C4 alkyl group and R²=H or a C1 to C4 alkyl group and x=1-3.

9. The fertilizer composition of claim 8 wherein the carboxylic acid salt of potassium is selected from the group consisting of potassium formate, potassium acetate, potassium propionate, potassium butyrate, potassium valerate, potassium hexanoate, potassium oxalate, potassium malonate, potassium succinate, potassium glutarate, potassium adipate, potassium lactate, potassium malate, potassium citrate, potassium glycolate, potassium tartrate, potassium glyoxylate, potassium pyruvate, and combinations thereof.

10. The fertilizer composition of claim 9 wherein the carboxylic acid salt of potassium is selected from the group consisting of potassium formate, potassium acetate, potassium propionate, potassium lactate, potassium malate, potassium citrate, potassium tartrate, potassium pyruvate, and combinations thereof.

11. The fertilizer composition of claim 1 wherein the fertilizer composition has a pH of about 5.5 to about 10.5.

12. The fertilizer composition of claim 1 further comprising from 0 wt % to 25 wt % of a secondary nutrient selected from the group consisting of sulfur, zinc, boron, calcium, manganese, iron, copper, cobalt, magnesium, or a combination thereof.

13. The fertilizer composition of claim 12 wherein the secondary nutrient is derived potassium thiosulfate, ammonium thiosulfate, zinc ethylenediaminetetraacetic acid (ZnEDTA), calcium ethylene-diaminetetraacetic acid (CaEDTA), ammonium calcium nitrate, manganese ethylene-diaminetetraacetic acid (MnEDTA), iron ethylenediaminetetraacetic acid (FeEDTA), iron N-(hydroxyethyl) ethylene-diaminetriacetic acid (FeHEDTA), iron ethylenediamine-N, N¹-bis (2-hydroxyphenylacetic acid) (FeEDDHA), iron ethylene-diamine-di (2-hydroxy-5-sulfophenylacetic acid) (FeEDDHSA), cobalt ethylenediaminetetraacetic acid (CoEDTA), cobalt sulfate, magnesium ethylenediaminetetraacetic acid (MgEDTA), copper ethylene-diaminetetraacetic acid (CuEDTA), sodium borate, disodium octaborate tetrahydrate, boric acid, and combinations thereof.

14. The fertilizer composition of claim 1 further comprising poly-aspartic acid, amino polycarboxylic acid, or an inoculant, or a combination thereof.

15. The fertilizer composition of claim 1 wherein the composition is applied by in-furrow application, foliar application, side-dress treatment after planting, pre-planting soil injection, broadcast application, banding 2×2, fertigation, subsurface drip, drip tape, micro-jet, center pivot, surface drip, flood, sprinkler, and combinations thereof.

16. The fertilizer of claim 1 wherein the salt index is not greater than about 40.

17. The fertilizer of claim 16 wherein the salt index is not greater than about 38.

18. A fertilizer composition consisting essentially of:
a. a nitrogen source which delivers from 0.0% to 12.0% available nitrogen in the final composition;
b. a phosphate source which delivers from 0% to 25% available phosphate in the form of P₂O₅ in the final composition;
c. an organic potassium source which delivers from 10% to 40% available potassium in the form of K₂O in the final composition, and wherein the organic potassium source is selected from the group consisting of potassium phosphate, organic sources of potassium, animal manure, carboxylic acid salts of potassium, potassium silicate and combinations thereof; and,
d. 0% to 25% sulfur, zinc, boron, calcium, manganese, iron, copper, cobalt, magnesium, poly-aspartic acid, amino polycarboxylic acid, an inoculant, or a combination thereof,
and wherein said composition has a salt index not greater than about 40 as measured by electrical conductivity methods.

19. The fertilizer composition of claim 18 wherein the nitrogen source selected from the group consisting of urea, nitrate, triazone urea, urea triazone solution, ammonia, ammonium salts, ammonium hydroxide, amino acids, fish meal or extract, compost extract, kelp extract, shrimp extract, shellfish extract, and combinations thereof; and wherein the phosphate source is selected from the group consisting of rock phosphate, sodium phosphate, potassium phosphate, phosphoric acid, bone meal, monopotassium phosphate, dipotassium phosphate, tetrapotassium pyrophosphate, ammonium phosphate, calcium phosphate, and combinations thereof.

20. The fertilizer composition of claim 18 wherein the carboxylic acid salt of potassium is selected from (1) HCOOK, or (2) CH₃(CH₂)ₓCOOK wherein x=0-4, or (3) MOOC(CR¹R²)ₓCOOK wherein R¹=—H or —OH or —COOM and R²=—H or —OH or —COOM and x=0-4 and M=H or K, or (4) HO(CR¹R²)ₓCOOK wherein R¹=H or a C1 to C4 alkyl group and R²=H or a C1 to C4 alkyl group and x=1-5, or (5) CH₃CO(CR¹R²)ₓCOOK wherein R¹=H or a C1 to C4 alkyl group and R²=H or a C1 to C4 alkyl group and x=1-3.
